(19) United States
(12) Patent Application Publication
(10) Pub. No.: US 2019/0164327 A1
(43) Pub. Date: May 30, 2019

(54) HUMAN-COMPUTER INTERACTION DEVICE AND ANIMATED DISPLAY METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIN-GUO LIU, Shenzhen (CN)

(21) Appl. No.: 15/859,767

(22) Filed: Jan. 2, 2018

(30) Foreign Application Priority Data
Nov. 30, 2017 (CN) 201711241864.2

(51) Int. Cl. G06T 13/40; G10L 15/18; G10L 25/63; G06K 9/00

(52) U.S. Cl. CPC G06T 13/40; G10L 15/1815; G10L 25/63; G06F 3/0482; G06K 9/00288; G06K 9/00255; G06T 2200/24; G06K 9/00302

(57) ABSTRACT

A method of animating a display to reflect mood is applied in a human-computer interaction device. The method acquires voice of user, recognizes the voice content and analyzes context of the voice. The context comprises user semantic and user emotion feature. The method further compares the context with a first relationship table, which defines a relationship between a number of preset contexts and a number of preset animated images. The method further determines a target image from the first relationship table when the context is matched therein, and displays the animation of the target image on a display unit of the human-computer interaction device.

### CROSS-REFERENCE TO RELATED APPLICATIONS

This application claims priority to Chinese Patent Application No. 201711241864.2 filed on Nov. 30, 2017, the contents of which are incorporated by reference herein.

### FIELD

The subject matter herein generally relates to display technology field, and particularly, to a human-computer interaction device and an animated display method.

### BACKGROUND

The present animation and image of the animation cannot reflect user's emotions, which lacks vividness. Therefore, a human-computer interaction device and an animated display method are required to reflect user's emotions.

### BRIEF DESCRIPTION OF THE DRAWINGS

Implementations of the present disclosure will now be described, by way of example only, with reference to the attached figures.

FIG. 1 is a diagram of one embodiment of a running environment of a human-computer interaction system.

FIG. 2 is a block diagram of one embodiment of a human-computer interaction device in the system of FIG. 1.

FIG. 3 is a block diagram of one embodiment of the human-computer interaction system of FIG. 1.

FIG. 4 is a diagram of one embodiment of a first relationship applied in the system of FIG. 1.

FIG. 5 is a diagram of another embodiment of the first relationship.

FIG. 6 is a diagram of one embodiment of an expression selection interface applied in the system of FIG. 1.

FIG. 7 is a diagram of one embodiment of a head portrait selection interface applied in the system of FIG. 1.

FIG. 8 is a flowchart of one embodiment of an animated display method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

Exemplary embodiments of the present disclosure will be described in relation to the accompanying drawings.

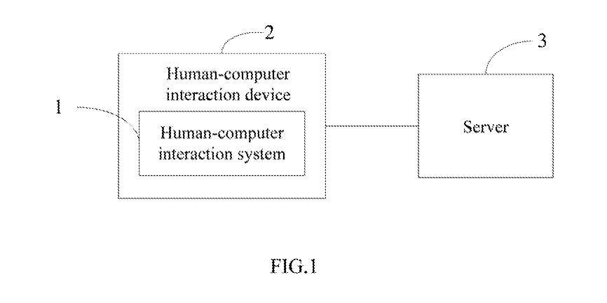

FIG. 1 illustrates a running environment of a human-computer interaction system 1. The system 1 runs in a human-computer interaction device 2. The human-computer interaction device 2 communicates with a server 3. The human-computer interaction device 2 displays a human-computer interaction interface (not shown), by which a user interacts with the device 2. The system 1 controls the human-computer interaction device 2 to display an animated image on the human-computer interaction interface. In at least one exemplary embodiment, the human-computer interaction device 2 can be a smart phone, a smart robot, or a computer.

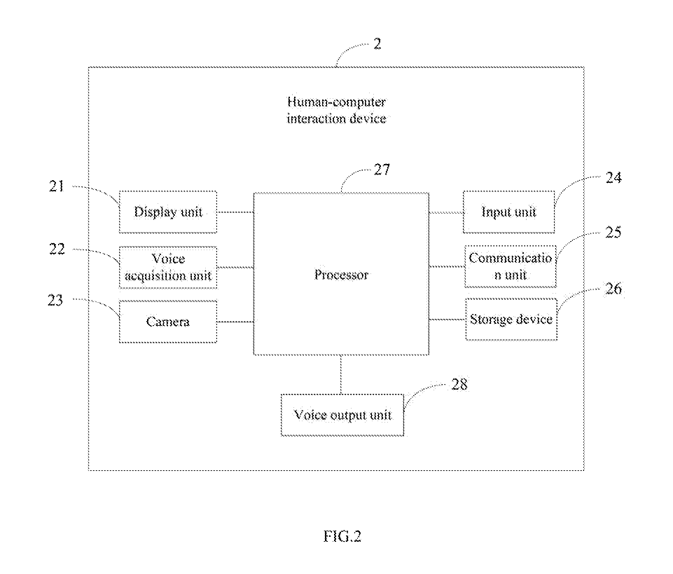

FIG. 2 illustrates the human-computer interaction device 2. In at least one exemplary embodiment, the human-computer interaction device 2 includes, but is not limited to, a display unit 21, a voice acquisition unit 22, a camera 23, an input unit 24, a communication unit 25, a storage device 26, a processor 27, and a voice output unit 28. The display unit 21 is used to display content of the human-computer interaction device 2, such as the human-computer interaction interface or the animated image. In at least one exemplary embodiment, the display unit 21 can be a liquid crystal display screen or an organic compound display screen. The voice acquisition unit 22 is used to collect user's voice and transmits the voice to the processor 27. In at least one exemplary embodiment, the voice acquisition unit 22 can be microphone or microphone array. The camera 23 shoots user's face image and transmits user's face image to the processor 27. The input unit 24 receives user's input information. In at least one exemplary embodiment, the input unit 24 and the display unit 21 can be a touch display screen. The human-computer interaction device 2 can receive user's input information and display the content of the human-computer interaction device 2 through the touch display screen. Through the communication unit 25, the human-computer interaction device 2 can connect to the server 3. In at least one exemplary embodiment, the communication unit 25 can be a WIFI communication chip, a ZIGBEE communication chip or a BLUE TOOTH communication chip. In another embodiment, the communication unit 25 can be an optical fiber or a cable. The voice output unit 28 outputs sound. In at least one exemplary embodiment, the voice output unit 28 can be a speaker.

The storage device 26 stores program code of data of the human-computer interaction device 2 and the human-computer interaction system 1. In at least one exemplary embodiment, the storage device 26 can include various types of non-transitory computer-readable storage mediums. For example, the storage device 26 can be an internal storage system of the human-computer interaction device 2, such as a flash memory, a random access memory (RAM) for temporary storage of information, and/or a read-only memory (ROM) for permanent storage of information. In at least one exemplary embodiment, the processing unit 27 can be a central processing unit (CPU), a microprocessor, or other data processor chip that performs functions of the human-computer interaction system 1.

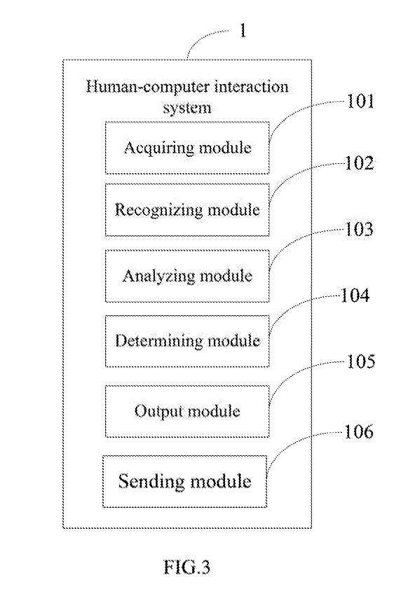

FIG. 3 illustrates the human-computer interaction system 1. In at least one exemplary embodiment, the human-computer interaction system 1 includes, but is not limited to, an acquiring module 101, a recognizing module 102, an analyzing module 103, a determining module 104, and an output module 105. The modules 101-105 of the human-computer interaction system 1 can be collections of software instructions. In at least one exemplary embodiment, the software instructions of the acquiring module 101, the recognizing module 102, the analyzing module 103, the determining module 104, and the output module 105 are stored in the storage device 26 and executed by the processor 27.

The acquiring module 101 acquires the voice collected by the voice acquisition unit 25.

The recognizing module 102 recognizes the voice and analyzes context of the voice, wherein the context comprises user semantic and user emotion feature. In at least one exemplary embodiment, user emotion feature includes emotions such as happy, worried, sad, angry, and the like. For example, when the acquiring module 101 acquires user's voice saying “what a nice day!”, the recognizing module 102 recognizes user semantic of “what a nice day!” as “it is a nice day”, and recognizes user emotion feature of “what a nice day!” as “happy”. For another example, when the acquiring module 101 acquires user's voice saying “what a bad day!”, the recognizing module 102 recognizes user semantic of “what a bad day!” as “it is a bad day”, and recognizes user emotion feature of “what a bad day!” as “sad”.

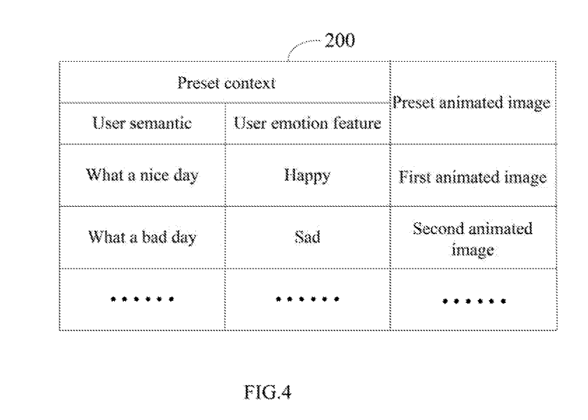

The analyzing module 103 compares the context with a first relationship table 200. FIG. 4 illustrates an embodiment of the first relationship 200. The first relationship table 200 includes a number of preset context and a plurality of preset animated images, and the first relationship table 200 defines a relationship between the number of preset contexts and the number of preset animated images.

The determining module 104 determines a target image from the first relationship table 200 when the context matches with the preset context of the first relationship table 200. The output module 105 displays the target image on the display unit 21. In the first relationship table 200 (referring to FIG. 4), when the user semantic of the context is “it is a nice day” and the user emotion feature of the context is “happy”, the preset animated image corresponding to the context is a first animated image. For example, the first animated image is an image in which a cartoon of the animated image rotates. When the user semantic of the context is “it is a bad day” and the user emotion feature of the context is “sad”, the preset animated image corresponding to the context is a second animated image. For example, the second animated image is an image in which a cartoon of the animated image is crying. In at least one exemplary embodiment, the analyzing module 103 compares the context with the first relationship table 200. When the context matches with the first animated image of the first relationship table 200, the determining module 104 determines the first animated image as being the target image. When the context matches with the second animated image of the first relationship table 200, the determining module 104 determines the second animated image as being the target image. In at least one exemplary embodiment, the first relationship table 200 is stored in the storage device 26. In another embodiment, the first relationship table 200 is stored in the server 3.

In at least one exemplary embodiment, the acquiring module 101 controls the camera 23 to shoot image of user face. The analyzing module 103 analyzes user expression from the image of user face. The determining module 104 further determines the user expression as an expression of the target image. In at least one exemplary embodiment, the storage device 26 stores a second relationship table (not show), the second relationship table includes a number of preset face images and a number of expressions, the second relationship table defines a relationship between the number of preset face images and the number of expressions. The determining module 104 compares the user expression with the second relationship table and determines an expression which matches with the image of user face. In another embodiment, the second relationship table can be stored in the server 2.

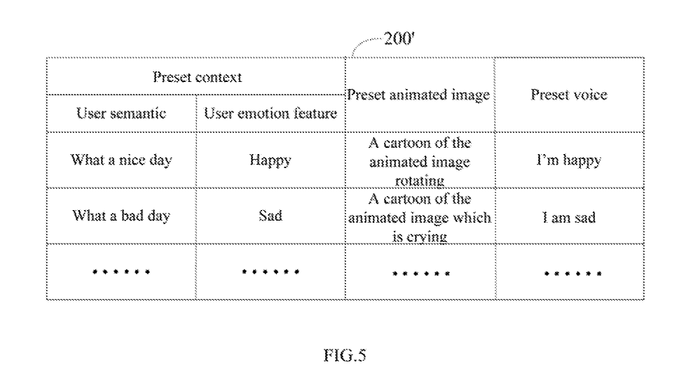

In at least one exemplary embodiment, the first relationship table 200′ (referring to FIG. 5) further includes a number of preset contexts, a plurality of preset animated images, and a number of preset voices. The first relationship table 200′ defines a relationship among the number of preset contexts, the number of preset animated images, and the number of preset voices. The determining module 104 further compares the context of the voice collected by the voice acquisition unit 22 with the first relationship table 200′. When the context matches with the preset context in the first relationship table 200′, the determining module 104 determines a target image and a target voice which corresponds to the preset context. In the first relationship table 200′, when the user semantic of the context is “it is a nice day” and the user emotion feature of the context is “happy”, the preset animated image corresponding to the context is that a cartoon of the animated image rotating, and the preset voice corresponding to the context is “I'm happy”. When the user semantic of the context is “it is a bad day” and the user emotion feature of the context is “sad”, the preset animated image corresponding to the context is a cartoon of the animated image which is crying, and the preset voice corresponding to the context is “I am sad”. The analyzing module 103 compares the context within the first relationship table 200′. The determining module 104 determines a preset animated image corresponding to the context as the target image, and determines a preset animated image corresponding to the context as the target voice. The output module 105 displays the target image on the display unit 21, and controls the voice output unit 28 to output the target voice.

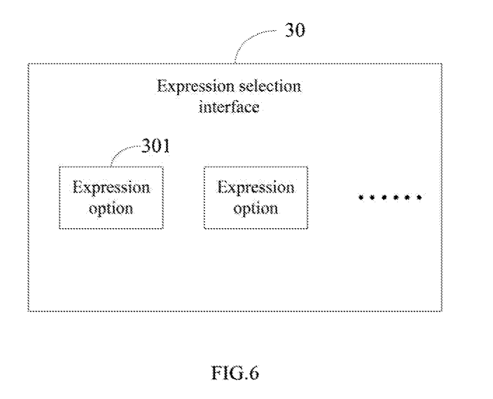

In at least one exemplary embodiment, the acquiring module 101 further receives an expression setting input by the input unit 24. The determining module 104 determines an expression of the target image according to the expression setting. In at least one exemplary embodiment, the output module 105 controls the display unit 21 to display an expression selection interface 30. FIG. 6 illustrates the expression selection interface 30. The expression selection interface 30 includes a number of expression options 301. Each expression option 301 corresponds to an expression of the animated image, such as happy, worried, sad, angry, and the like. The acquiring module 101 receives one of the expression options 301 input by the input unit 24, and the determining module 104 determines an expression of the target image according to the expression option 301.

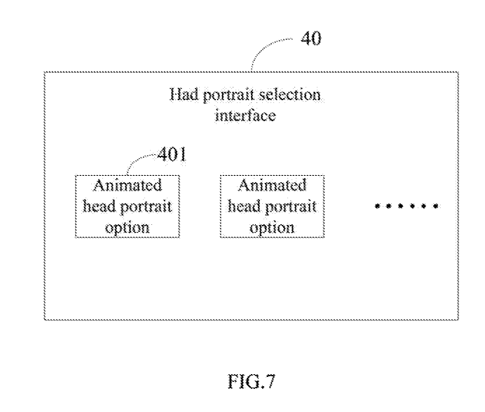

In at least one exemplary embodiment, the output module 105 controls the display unit 21 to display a head portrait selection interface 40. FIG. 7 illustrates the head portrait selection interface 40. The head portrait selection interface 40 includes a number of options (animated head portrait options 401) of an animated head portrait. Each animated head portrait option 401 corresponds to an animated head portrait of an image. The acquiring module 101 receives one of the animated head portrait options 401 input by user, and the determining module 104 determines a head portrait of the target image according to the animated head portrait option 401.

In at least one exemplary embodiment, the human-computer interaction system 1 further includes a sending module 106. The sending module 106 receives configuration information of the target image input by the input unit 24. In at least one exemplary embodiment, the configuration information of the target image includes expression appearing on the target image and head portrait of the target image. The sending module 106 sends the configuration information to the server 3 to control the server 3 to generate the animated target image according to the configuration information. In at least one exemplary embodiment, the acquiring module 101 receives the target image sent by the server 3. The output module 105 controls the display unit 21 to display the received animated target image.

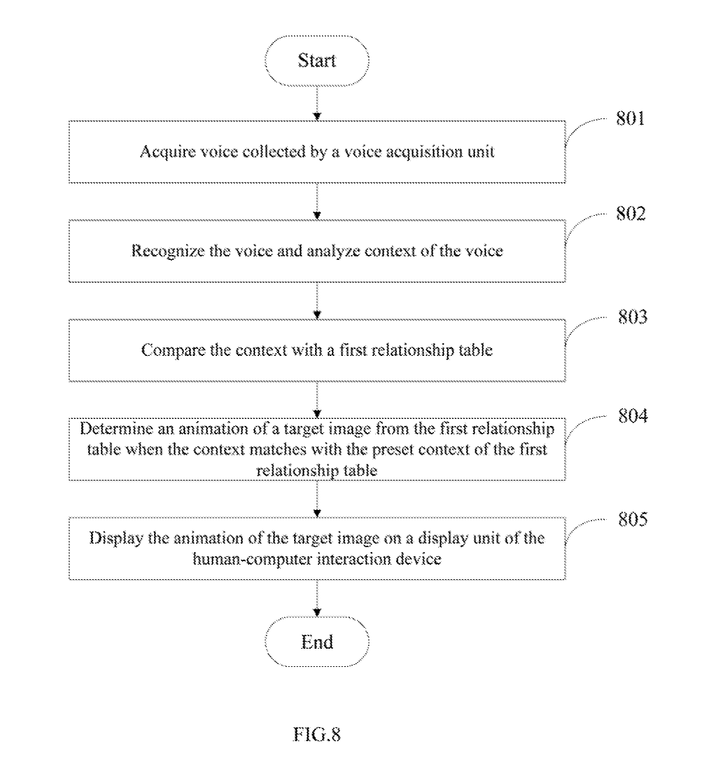

FIG. 8 illustrates a flowchart of one embodiment of an animated display method. The animated display method is applied in a human-computer interaction device. The method is provided by way of example, as there are a variety of ways to carry out the method. The method described below can be carried out using the configurations illustrated in FIGS. 1-7, for example, and various elements of these figures are referenced in explaining the example method. Each block shown in FIG. 8 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 801.

At block 801, the human-computer interaction device acquires voice collected by a voice acquisition unit.

At block 802, the human-computer interaction device recognizes the voice and analyzes context of the voice, wherein the context comprises user semantic and user emotion feature.

In at least one exemplary embodiment, user emotion feature includes emotions such as happy, worried, sad, angry, and the like. For example, when acquiring user's voice saying “what a nice day!”, the human-computer interaction device recognizes user semantic of “what a nice day!” as “it is a nice day”, and recognizes user emotion feature of “what a nice day!” as “happy”. For another example, when acquiring user's voice saying “what a bad day!”, the human-computer interaction device recognizes user semantic of “what a bad day!” as “it is a bad day”, and recognizes user emotion feature of “what a bad day!” as “sad”.

At block 803, the human-computer interaction device compares the context with a first relationship table. In at least one exemplary embodiment, the human-computer interaction device includes a number of preset contexts and a plurality of preset animated images, and the first relationship table defines a relationship between the number of preset contexts and the number of preset animated images.

At block 804, the human-computer interaction device determines an animation of a target image from the first relationship table when the context matches with the preset context of the first relationship table.

In the first relationship table, when the user semantic of the context is “it is a nice day” and the user emotion feature of the context is “happy”, the preset animated image corresponding to the context is a first animated image. For example, the first animated image is an image in which a cartoon of the animated image is made to rotate. When the user semantic of the context is “it is a bad day” and the user emotion feature of the context is “sad”, the preset animated image corresponding to the context is a second animated image. For example, the second animated image is an image in which a cartoon of the animated image is made to cry. In at least one exemplary embodiment, the human-computer interaction device compares the context with the first relationship table. When the context matches with the first animated image of the first relationship table, the human-computer interaction device determines the first animated image as being the target image. When the context matches with the second animated image of the first relationship table, the human-computer interaction device determines the second animated image as being the target image.

At block 805, the human-computer interaction device displays the animation of the target image on a display unit of the human-computer interaction device.

In at least one exemplary embodiment, the method further includes the human-computer interaction device controlling a camera of the human-computer interaction device, to shoot image of user face. The human-computer interaction device further analyzes user expression from the image of user face, and determines the user expression in the image which has been shot. In at least one exemplary embodiment, a storage device of the human-computer interaction device stores a second relationship table (not show), the second relationship table includes a number of preset face images and a number of expressions. The second relationship table defines a relationship between the number of preset face images and the number of expressions. The human-computer interaction device compares the user expression within the second relationship table and determines an expression which matches with the user face image. In another embodiment, the second relationship table can be stored in a server communicating with the human-computer interaction device.

In at least one exemplary embodiment, the first relationship table (referring to FIG. 5) further includes a number of preset contexts, a plurality of preset animated images, and a number of preset voices. The first relationship table defines a relationship among the number of preset contexts, the number of preset animated images and the number of preset voices. The method further includes the human-computer interaction device comparing the context of the voice collected by a voice acquisition unit of the human-computer interaction device within the first relationship table, and determining a target image and a target voice corresponding to the preset context when the context matches with the preset context in the first relationship table.

In the first relationship table, when the user semantic of the context is “it is a nice day” and the user emotion feature of the context is “happy”, the preset animated image corresponding to the context is a cartoon of the animated image rotating, and the preset voice corresponding to the context is that “I'm happy”. When the user semantic of the context is “it is a bad day” and the user emotion feature of the context is “sad”, the preset animated image corresponding to the context is a cartoon of the animated image which is crying, and the preset voice corresponding to the context is “I am sad”. In at least one exemplary embodiment, the human-computer interaction device compares the context with the first relationship table, determines a preset animated image corresponding to the context as the target image and a preset animated image corresponding to the context as the target voice. The target image is displayed on the display unit, and a voice output unit of the human-computer interaction device is controlled to output the target voice.

In at least one exemplary embodiment, the method further includes the human-computer interaction device further receiving an expression setting input by an input unit of the human-computer interaction device, and determining an expression of the target image according to the expression setting.

In at least one exemplary embodiment, the human-computer interaction device controls the display unit to display an expression selection interface (referring to FIG. 6). The expression selection interface includes a number of expression options. Each expression option corresponds to an expression of the animated image, such as happiness, anxiety, sadness, anger, and the like. The human-computer interaction device receives one of the expression options input by the input unit, and determines an expression of the target image according to the expression option.

In at least one exemplary embodiment, the method further includes the human-computer interaction device controlling the display unit 21 to display a head portrait selection interface (referring to FIG. 7). The head portrait selection interface includes a number of options for animations of head portraits. Each animated head portrait option corresponds to an animated head portrait image. The human-computer interaction device receives one of the animated head portrait options input by user, and determines an option of an animation of the target head portrait.

In at least one exemplary embodiment, the method further includes the human-computer interaction device receiving configuration information of the target image input by the input unit, sending the configuration information to the server to control the server to generate the animation of the target image according to the configuration information. In at least one exemplary embodiment, the configuration information of the target image includes expression of the target image and head portrait of the target image.

In at least one exemplary embodiment, the human-computer interaction device receives the target image sent by the server, and controls the display unit to display the received target image.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size, and arrangement of the parts within the principles of the present disclosure up to and including the full extent established by the broad general meaning of the terms used in the claims.

What is claimed is:

1. A human-computer interaction device comprising:
a display unit;
a voice acquisition unit configured to collect user's voice;
a processor coupled to the display unit and the voice acquisition unit;
a non-transitory storage medium coupled to the processor and configured to store a plurality of instructions, which cause the processor to control the device to:
acquire the voice collected by the voice acquisition unit;
recognize the voice and analyze context of the voice, wherein the context comprises user semantic and user emotion feature;
compare the context with a first relationship table, wherein the first relationship table comprises a plurality of preset context and a plurality of preset animated images, the first relationship table defines a relationship between the plurality of preset context and the plurality of preset animated images;
determine a target image from the first relationship table when the context matches with the preset context of the first relationship table; and
display the target image on the display unit.

2. The human-computer interaction device as recited in claim 1, further comprising a camera, wherein the plurality of instructions are further configured to cause the processor to:
control the camera to shoot an image of user face;
analyze user expression from the image of user face; and
determine the user expression as an expression of the target image displayed on the display unit.

3. The human-computer interaction device as recited in claim 1, further comprising an input unit, wherein the plurality of instructions are further configured to cause the processor to:
receive an expression setting input by the input unit; and
determine an expression of the target image according to the expression setting.

4. The human-computer interaction device as recited in claim 3, wherein the plurality of instructions are further configured to cause the processor to:
control the display unit to display an expression selection interface, wherein the expression selection interface comprises a plurality of expression options, each expression option corresponds to an expression of the animated image;
receives one of the expression options input by the input unit; and
determines the expression of the target image according to the expression option.

5. The human-computer interaction device as recited in claim 1, wherein the plurality of instructions are further configured to cause the processor to:
control the display unit to display a head portrait selection interface, wherein the head portrait selection interface comprises a plurality of animated head portrait options, each animated head portrait option corresponds to an animated head portrait; and
determine an animated head portrait corresponding to an animated head portrait option selected by user as the animated head portrait of the target image displayed on the display unit.

6. The human-computer interaction device as recited in claim 3, further comprising a communication unit configured to connect to a server, wherein the plurality of instructions are further configured to cause the processor to:
receive configuration information of the target image input by the input unit, wherein the configuration information of the target image comprises expression and head portrait;
send the configuration information to the server to control the server to generate the target image according to the configuration information;
receive the generated target image sent by the server; and
display the processed target image.

7. An animated display method, applied in a human-computer interaction device, the method comprising:
acquiring voice collected by a voice acquisition unit of the human-computer interaction device;
recognizing the voice and analyzing context of the voice, wherein the context comprises user semantic and user emotion feature;
comparing the context with a first relationship table, wherein the first relationship table comprises a plurality of preset context and a plurality of preset animated images, the first relationship table defines a relationship between the plurality of preset context and the plurality of preset animated images;
determining a target image from the first relationship table when the context is matched with the first relationship table; and
displaying the target image on a display unit of the human-computer interaction device.

8. The method as recited in claim 7, further comprising:
controlling a camera of the human-computer interaction device to shoot an image of user face;
analyzing user expression from the image of user face; and
determining the user expression as an expression of the target image displayed on the display unit.

9. The method as recited in claim 7, further comprising:
receiving an expression setting input by the input unit; and
determining an expression of the target image according to the expression setting.

10. The method as recited in claim 9, further comprising:
controlling the display unit to display an expression selection interface, wherein the expression selection interface comprises a plurality of expression options, each expression option corresponds to an expression of the animated image;
receiving one of the expression options input by the input unit; and
determining the expression of the target image according to the expression option.

11. The method as recited in claim 7, further comprising:
controlling the display unit to display a head portrait selection interface, wherein the head portrait selection interface comprises a plurality of animated head portrait options, each animated head portrait option corresponds to an animated head portrait; and
determining an animated head portrait corresponding to an animated head portrait option selected by user as the animated head portrait of the target image displayed on the display unit.

12. The method as recited in claim 7, further comprising:
receiving configuration information of the target image input by the input unit, wherein the configuration information of the target image comprises expression and head portrait;
sending the configuration information to a server communicated with the human-computer interaction device to control the server to generate the target image according to the configuration information;
receiving the generated target image sent by the server; and
displaying the processed target image.

13. A non-transitory storage medium having stored thereon instructions that, when executed by a processor of a human-computer interaction device, causes the processor to execute instructions of an animated display method using the human-computer interaction device, the method comprising:
acquiring voice collected by a voice acquisition unit of the human-computer interaction device;
recognizing the voice and analyzing context of the voice, wherein the context comprises user semantic and user emotion feature;
comparing the context with a first relationship table, wherein the first relationship table comprises a plurality of preset context and a plurality of preset animated images, the first relationship table defines a relationship between the plurality of preset context and the plurality of preset animated images;
determining a target image from the first relationship table when the context is matched with the first relationship table; and
displaying the target image on a display unit of the human-computer interaction device.

14. The non-transitory storage medium according to claim 13, wherein the method is further comprising:
controlling a camera of the human-computer interaction device to shoot an image of user face;
analyzing user expression from the image of user face; and
determining the user expression as an expression of the target image displayed on the display unit.

15. The non-transitory storage medium according to claim 13, wherein the method is further comprising:
receiving an expression setting input by the input unit; and
determining an expression of the target image according to the expression setting.

16. The non-transitory storage medium according to claim 15, wherein the method is further comprising:
controlling the display unit to display an expression selection interface, wherein the expression selection interface comprises a plurality of expression options, each expression option corresponds to an expression of the animated image;
receiving one of the expression options input by the input unit; and
determining the expression of the target image according to the expression option.

17. The non-transitory storage medium according to claim 13, wherein the method is further comprising:
controlling the display unit to display a head portrait selection interface, wherein the head portrait selection interface comprises a plurality of animated head portrait options, each animated head portrait option corresponds to an animated head portrait; and
determining an animated head portrait corresponding to an animated head portrait option selected by user as the animated head portrait of the target image displayed on the display unit.

18. The non-transitory storage medium according to claim 13, wherein the method is further comprising:
receiving configuration information of the target image input by the input unit, wherein the configuration information of the target image comprises expression and head portrait;
sending the configuration information to a server communicated with the human-computer interaction device to control the server to generate the target image according to the configuration information;
receiving the generated target image sent by the server; and
displaying the processed target image.
